(19) United States
(12) Patent Application Publication
(10) Pub. No.: US 2026/0196828 A1
(43) Pub. Date: Jul. 9, 2026

(54) Power Supply Control Circuit, System, and Method

(71) Applicant: Anker Innovations Technology Co., Ltd., Changsha (CN)

(72) Inventor: Jinyong Wang, Shenzhen (CN)

(21) Appl. No.: 19/442,261

(22) Filed: Jan. 7, 2026

(30) Foreign Application Priority Data
Jan. 8, 2025 (CN) 202510030825.6
Jan. 8, 2025 (CN) 202520043153.8

(51) Int. Cl. H02J 1/08; H02J 1/00

(52) U.S. Cl. CPC H02J 1/084; H02J 1/001

(57) ABSTRACT

A power supply control circuit comprises: a switch circuit connected between an auxiliary power supply terminal of a battery module and a main control module, and a fast turn-on circuit connected to a control terminal of the switch circuit, and configured to generate a first switch control signal based on a fast start signal of the main control module. The power supply control circuit also comprises a power supply detection circuit connected to the control terminal of the switch circuit, and configured to generate a second switch control signal based on an auxiliary power supply control signal of the battery module. The switch circuit can be turned on based on an indication from at least one of the first switch control signal and the second switch signal. The power supply control circuit also comprises a power consumption control circuit connected to the power supply detection circuit.

### CROSS-REFERENCE TO RELATED APPLICATIONS

The present application claims priority to Chinese Patent Application No. 202520043153.8, filed on January 8, 2025, entitled “POWER SUPPLY CONTROL CIRCUIT AND SYSTEM”, and Chinese Patent Application No. 202510030825.6, filed on January 8, 2025, entitled “POWER SUPPLY CONTROL CIRCUIT, SYSTEM, AND METHOD”, each of which is herein incorporated by reference in its entirety.

### FIELD

The present disclosure relates to the technical field of battery switching, particularly to a power supply control circuit, system, and method.

### BACKGROUND

In the related art, a device supports the simultaneous connection of two battery packs, and the two battery packs can serve as backups for each other to supply power to the device. During battery pack supplying power, it is necessary to provide a power supply voltage ensuring normal operation of the device. When the charge level of one battery pack is insufficient to support normal operation of the device, it is necessary to switch to a battery pack with sufficient charge to continue supplying power to the device.

There are two common switching methods. In the first method, the two battery packs that back up each other switch instantaneously, avoiding power disconnection of the device, but there may be a difference between output voltages of main and sub battery packs during the switching process, causing a sudden change of the power supply voltage of the device in operation. The sudden change of the voltage causes an impact on the device, easily leading to damage to the device. In the second method, through a plugging operation, the battery pack with a low charging level is replaced with the battery pack with a sufficient charging level, but hot plug is not supported during the power supply of the device. Additionally, the power supply is cut off for a short time, leading to interruption of part of functions of the device, and affecting the normal operation of the device.

### SUMMARY

In view of the above problem, the present disclosure provides a power supply control circuit, system, and method to solve the technical problem of function interruption caused by cutoff of the power supply during battery switching in the dual-battery equipment.

In a first aspect, an example of the present disclosure provides a power supply control circuit comprising: a switch circuit connected between an auxiliary power supply terminal of a battery module and a main control module, and a fast turn-on circuit connected to a control terminal of the switch circuit, and configured to generate a first switch control signal based on a fast start signal of the main control module. The power supply control circuit also comprises a power supply detection circuit connected to the control terminal of the switch circuit, and configured to generate a second switch control signal based on an auxiliary power supply control signal of the battery module. The switch circuit can be turned on based on an indication from at least one of the first switch control signal and the second switch signal. The power supply control circuit also comprises a power consumption control circuit connected to the power supply detection circuit. The power consumption control circuit can be configured to enable the power supply detection circuit based on an anti-power consumption signal received from the main control module.

In some examples, the fast turn-on circuit comprises: a first switch transistor, a first resistor, and a second resistor. The first switch transistor is connected between a control terminal of the switch circuit and a grounding terminal, the first resistor is connected between a first port of the main control module and a control terminal of the first switch transistor, and the second resistor is connected between a control terminal and a first terminal of the first switch transistor. The first port is configured to output (e.g., send) the fast start signal.

In some examples, the power supply detection circuit comprises: a second switch transistor, a third resistor, and a fourth resistor. The second switch transistor is connected between the control terminal of the switch circuit and the grounding terminal, the third resistor is connected between the auxiliary power supply control terminal of the battery module and a control terminal of the second switch transistor, and the fourth resistor is connected between the control terminal and a first terminal of the second switch transistor. The auxiliary power supply control terminal is configured to output the auxiliary power supply control signal.

In some examples, the power consumption control circuit comprises: a third switch transistor, a fifth resistor, and a sixth resistor. The third switch transistor is connected between the control terminal of the second switch transistor and the grounding terminal, the fifth resistor is connected between a second port of the main control module and a control terminal of the third switch transistor, and the sixth resistor is connected between the control terminal and a first terminal of the third switch transistor. The second port is configured to output the anti-power consumption signal.

In some examples, the switch circuit comprises: a fourth switch transistor, a seventh resistor, and an eighth resistor. The fourth switch transistor is connected between the auxiliary power supply terminal of the battery module and the main control module, one end of the seventh resistor is connected to a control terminal of the fourth switch transistor, the other end of the seventh resistor receives the first switch control signal and the second switch control signal, and the eighth resistor is connected between the control terminal and a first terminal of the fourth switch transistor.

In some examples, the power supply control circuit further comprises: an in-position detection circuit connected to the main control module, and configured to generate a first signal when the battery module is detected to be in position and generate a second signal when the battery module is detected to be removed.

In a second aspect, an example of the present disclosure provides a power supply control system comprising: at least two power supply control circuits described above, each of which corresponds to a respective battery module; and a main control module connected to the at least two power supply control circuits.

In some examples, the main control module is configured to: when the battery module in a power supply state is detected to be removed, output the fast start signal to the fast turn-on circuit corresponding to a first target battery module, such that the fast turn-on circuit turns on the corresponding switch circuit, and notify the first target battery module to start to supply power to the load circuit. Additionally or alternatively, the main control module is configured to, in response to a battery switching request, notify the battery module in the power supply state to stop supplying power to the load circuit, and output the fast start signal to the fast turn-on circuit corresponding to a second target battery module, such that the fast turn-on circuit turns on the corresponding switch circuit, and notifies the second target battery module to start to supply power to the load circuit.

In some examples, the main control module is further configured to, in response to the battery switching request, output the anti-power consumption signal to the power consumption control circuit corresponding to the battery module in the power supply state, such that the corresponding switch circuit is disconnected by the corresponding power supply detection circuit.

In some examples, the main control module is further configured to, in response to the battery switching request, notify the battery module in the power supply state to output the auxiliary power supply control signal, such that the corresponding switch circuit is disconnected by the corresponding power supply detection circuit.

In some examples, the main control module is further configured to: based on a determination that none of the battery modules in position supplies power to the load circuit, determine a third target battery module according to a preset logic, and notify the third target battery module to start to supply power to the load circuit.

In some examples, the power supply control system further includes: a voltage conversion circuit connected between the switch circuit of each of the power supply control circuits and the main control module, and configured to convert a voltage of the auxiliary power supply terminal of the battery module into a working voltage of the main control module.

In some examples, the voltage conversion circuit is further connected to the load power supply terminal of each of the battery modules, and is configured to convert a voltage of the load power supply terminal of the battery module into the working voltage of the main control module.

In some examples, the power supply control system further includes: a unidirectional turn-on unit connected between each of the switch circuits and the voltage conversion circuit, and connected between each of the auxiliary power supply terminals and the voltage conversion circuit.

In some examples, each of the battery modules includes: an auxiliary power supply terminal configured to supply power to the main control module; a load power supply terminal configured to supply power to a load circuit; a communication terminal in communication connection with the main control module; an auxiliary power supply control terminal configured to generate the auxiliary power supply control signal; an equipment detection circuit configured to generate a first signal when the battery module is detected to be in position, and generate a second signal when the battery module is detected to be removed; and a control unit configured to, when the battery module is detected to be in position, output the auxiliary power supply control signal indicating turning on the switch circuit to the power supply detection circuit through the auxiliary power supply control terminal; and when a power supply notification of the main control module is received through the communication terminal, start to supply power from the load power supply terminal to the load circuit.

In some examples, the control unit is further configured to, when a disconnection notification of the main control module is received through the communication terminal, output the auxiliary power supply control signal indicating to disconnect the switch circuit to the power supply detection circuit through the auxiliary power supply control terminal.

In a third aspect, an example of the present disclosure provides a power supply control method for the above power supply control system, comprising: detecting an in-position situation of a battery module, wherein the in-position situation includes determining whether at least one of main and sub battery modules are in position and a charge level of the battery module is sufficient; and determining whether to switch the battery module for power supply according to a detection result. If the main battery module and the sub battery module are both in position and have sufficient charge levels, the main control module selects the main battery module to supply power according to a preset logic, and closes power supply of the sub battery module, without switching the power supply. If the main battery module and the sub battery module are both in position, the charge level of the main battery module is insufficient, and the charge level of the sub battery module is sufficient, the main control module may close the power supply of the main battery module, and switch to the power supply of the sub battery module. If the main battery module instantaneously switches from an in-position state to a non-in-position state, the main control module may switch to the power supply of the sub battery module. The battery module power supply includes load power supply and auxiliary power supply.

The method may further comprise selecting a switching manner of the battery module for power supply based on determining whether to switch the battery module for power supply. If the main battery module is in position, the main control module simultaneously may output a communication signal and a fast start signal, the main control module may send the communication signal to the main battery module to close the load power supply, send the fast start signal to the power supply control circuit corresponding to the sub battery module to start the auxiliary power supply, subsequently send the communication signal to the sub battery module to start the load power supply, and send an anti-power consumption signal to the power supply control circuit corresponding to the main battery module to close the auxiliary power supply. If the main battery module is not in position, the main control module may send the fast start signal to the power supply control circuit corresponding to the sub battery module to start the auxiliary power supply, and subsequently send the communication signal to the power supply control circuit corresponding to the sub battery module to start the load power supply.

In some examples, when the main battery module and the sub battery module are both in position, the main battery module and the sub battery module both may output a first signal and an auxiliary power supply control signal, and the main control module may select the main battery module for power supply according to the received first signal, the received auxiliary power supply control signal, and the preset logic.

A manner of turning off the power supply of the sub battery module may include that the main control module sends the communication signal to the sub battery module, the sub battery module turns off the load power supply according to the communication signal, and the main control module sends the anti-power consumption signal to a sub power supply control circuit, to turn off the auxiliary power supply of the sub battery module. A priority of the anti-power consumption signal may be higher than a priority of the auxiliary power supply control signal.

In some examples, detection of the electric quantity of the battery module in position may include detecting whether a working voltage output by the battery module is smaller than a threshold voltage: if yes, the detection result is that the charge level of the battery module is insufficient. The threshold voltage may be a power supply voltage ensuring normal operation of a load circuit.

In the technical solution provided by the present disclosure, when the battery module is in position, the switch circuit between the auxiliary power supply terminal of the battery module and the main control module can be turned on by the power supply detection circuit based on the auxiliary power supply control signal of the battery module. During the battery switching, the switch circuit between the auxiliary power supply terminal of the battery module and the main control module may be turned on by the fast turn-on circuit based on the fast start signal of the main control module, avoiding function interruption caused by power interruption of the main control module. After the battery is switched to serve as the backup battery, the power supply detection circuit is enabled by the power consumption control circuit based on the anti-power consumption signal of the main control module to disconnect the switch circuit, which can avoid consuming the electric quantity of the backup battery.

These aspects or other aspects of the disclosure will be clearer to understand in the following description of examples.

### BRIEF DESCRIPTION OF THE DRAWINGS

In order to more clearly illustrate technical solutions in the present disclosure, drawings that need to be used in description of the examples are briefly introduced below, and it will be apparent in to those of ordinary skill in the art that the drawings in the following description are only some examples of the disclosure, and other drawings can be obtained in accordance with these drawings without inventive work.

FIG. 1 illustrates a schematic structural diagram of a power supply control circuit provided by an example of the present disclosure;

FIG. 2 illustrates a schematic structural diagram of a power supply control system provided by an example of the present disclosure;

FIG. 3 illustrates a schematic structural diagram of a battery module provided by an example of the present disclosure; and

FIG. 4 illustrates a schematic structural diagram of an electronic system provided by an example of the present disclosure.

### DETAILED DESCRIPTION

Detailed description will now be made to examples of the present disclosure, examples of which are illustrated in the accompanying drawings. The same or similar reference signs refer to the same or similar elements or elements having the same or similar functions throughout. The examples described below with reference to the accompanying drawings are exemplary, which are only used to explain the present disclosure, but shall not be construed to limit the present disclosure.

In order to make objects, technical solutions, and advantages of the disclosure clearer, the technical solutions in the disclosure will be clearly and fully described in combination with the accompanying drawings in the present disclosure. Obviously, the examples to be described are part of examples but not all examples of the disclosure. Based on the examples of the disclosure, all other examples obtained by those of ordinary skill in the art without inventive work shall fall within the scope of the disclosure.

In the disclosure, it should be noted that the relational terms such as "first" and "second" herein are merely used for distinguishing one entity or operation from another, and do not necessarily require or imply that any actual relationship or sequence exists between these entities or operations. Moreover, the terms "include", "comprise", and any variants thereof are intended to cover a non-exclusive inclusion, such that a process, method, article, or device including a series of elements not only includes those elements, but further includes other elements not listed explicitly, or includes inherent elements of the process, method, article, or device. In the absence of more limitations, an element defined by "include a..." does not exclude other same elements existing in the process, method, article, or equipment including the elements.

In the description of the present disclosure, words such as "example" or "for example" are used to indicate example, explanation or description. Any example or design scheme described as "exemplary" or "for example" in the present disclosure is not to be construed as preferred or advantageous over another example or design scheme. The use of words such as "example" or "for example" is intended to present relative concepts in a clear manner.

In the present disclosure, "a plurality of" means two or more than two, and in view of this, "a plurality of" can also be understood as "at least two" in the examples of the present disclosure. "At least one" can be understood as one or more, e. g., one, two, or more. For example, including at least one refers to including one, two, or more, and does not limit which is included, e. g., including at least one of A, B, and C may indicate including A, B, C, A and B, A and C, B and C, or A and B and C.

It should be noted in the disclosure that “and/or” describes an association relationship between associated objects, indicating that there may be three relationships. For example, A and/or B may indicate three cases: A alone, A and B at the same time, and B alone. The symbol “/” generally indicates that the relationship between the associated objects is “or” unless otherwise specified.

It should be noted that the term "connect" in the examples of the present disclosure may be understood as an electrical connection, and the connection between two electrical elements may be a direct connection or an indirect connection between two electrical elements. For example, a connection between A and B may be a direct connection between A and B, or an indirect connection between A and B through one or more other electrical elements.

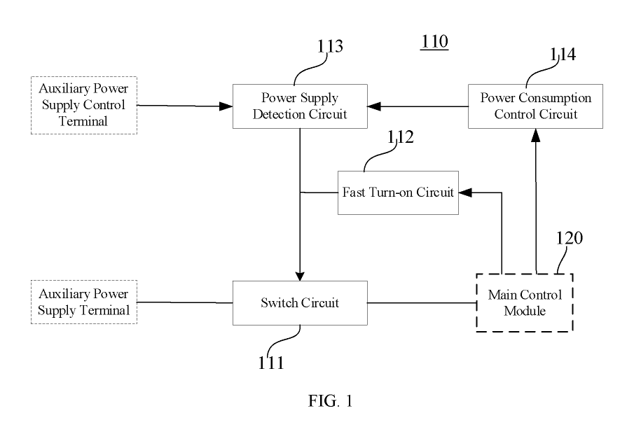

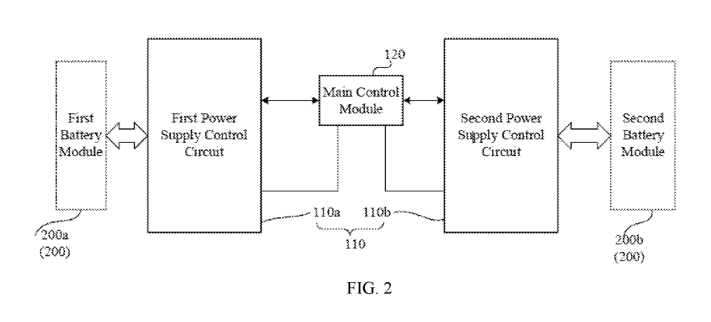

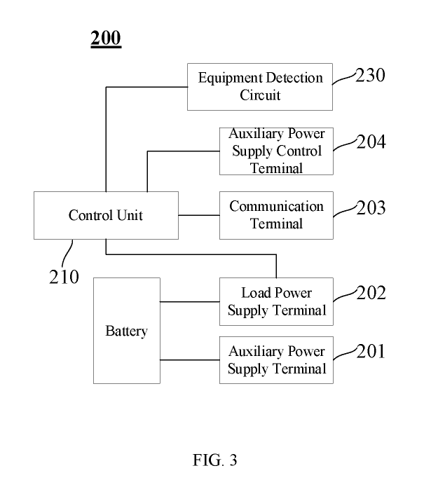

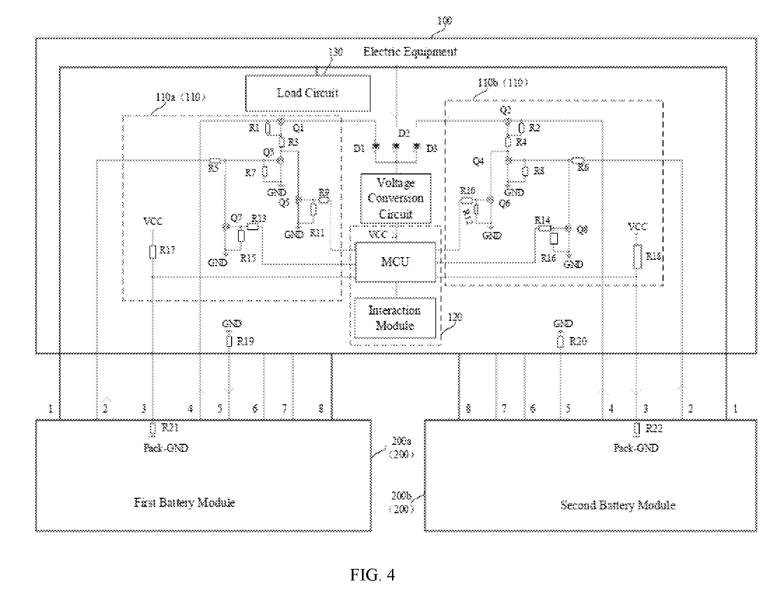

FIG. 1 illustrates a power supply control circuit of an example of the present disclosure, FIG. 2 illustrates a power supply control system including the power supply control circuit illustrated in FIG. 1, FIG. 3 illustrates a schematic structure of a battery module, and FIG. 4 illustrates a schematic diagram of an electronic system using the power supply control circuit, the power supply control system, and the battery module of the example of the present disclosure. The power supply control circuit and system of the example of the present disclosure are described below in combination with FIGS. 1 to FIG. 4.

Referring to FIGS. 1 and FIG. 2, in some examples, a power supply control circuit 110 may include a switch circuit 111, a fast turn-on circuit 112, a power supply detection circuit 113, and a power consumption control circuit 114. The switch circuit 111 is connected between an auxiliary power supply terminal of a battery module 200 and a main control module 120. The fast turn-on circuit 112 is connected to a control terminal of the switch circuit 111, and is configured to generate a first switch control signal based on a fast start signal of the main control module 120. The power supply detection circuit 113 is connected to the control terminal of the switch circuit 111, and is configured to generate a second switch control signal based on an auxiliary power supply control signal of the battery module 200.

The switch circuit 111 may be on when either of the first switch control signal and the second switch signal indicates on. For example, the power supply detection circuit 113 may turn on or off the switch circuit 111 based on an auxiliary power supply control signal of the battery module 200. The fast turn-on circuit 112 may turn on or off the switch circuit 111 based on the fast start signal of the main control module 120.

The power consumption control circuit 114 is connected to the power supply detection circuit 113, and is configured to enable the power supply detection circuit 113 based on an anti-power consumption signal of the main control module 120. Specifically, when the anti-power consumption signal indicates enabling the power supply detection circuit 113, the power supply detection circuit 113 is configured to generate the second switch control signal based on the auxiliary power supply control signal of the battery module 200. When the anti-power consumption signal indicates not enabling the power supply detection circuit 113, the power supply detection circuit 113 is configured to output the second switch control signal to indicate turning off the switch circuit 111.

Referring to FIGS. 3 and FIG. 4, in some examples, the battery module 200 includes: an auxiliary power supply terminal 201 (e.g., corresponding to a port 4 in FIG. 4) configured to supply power to the main control module 120; a load power supply terminal 202 (e.g., corresponding to ports 1 and 8 in FIG. 4) configured to supply power to a load circuit 130; a communication terminal 203 (e.g., corresponding to ports 6 and 7 in FIG. 4) in communication connection with the main control module 120; an auxiliary power supply control terminal 204 (e.g., corresponding to a port 2 in FIG. 4) configured to generate the auxiliary power supply control signal; an equipment detection circuit 230 (e.g., corresponding to a port 5 in FIG. 4) configured to generate a first signal when the battery module is detected to be in position, and generate a second signal when the battery module is detected to be removed; and a control unit 210 configured to, when the battery module is detected to be in position, output the auxiliary power supply control signal indicating turning on the switch circuit 111 to the power supply detection circuit 113 through the auxiliary power supply control terminal 204. When a power supply notification of the main control module 120 is received through the communication terminal 203, the control unit 210 is configured to control the load power supply terminal 202 to supply power to the load circuit 130.

Referring to FIG. 4, the electronic system includes electric equipment 100 and the battery module 200. The electric equipment 100 includes the power supply control circuit 110, the main control module 120, and the load circuit 130. As shown in FIG. 4, the main control module 120 may include a microcontroller (MCU) and an interaction module, and the interaction module may include output units such as a display screen, an indicator light, and a speaker.

In an example of the present disclosure, the electric equipment 100 may include at least two power supply control circuits 110, each of which corresponds to one battery module 200. The battery module 200 is configured to supply power to the electric equipment 100. The power supply control circuit 110 is configured to control power supply between the battery module 200 and the electric equipment 100. In an example of the disclosure, the main control module 120 may control the at least two power supply control circuits 110 respectively corresponding to the battery modules 200, such that one battery module 200 in the at least two battery modules 200 is a main battery, and the other battery modules 200 are backup batteries, and switching may be performed therebetween. For the sake of simplicity, as shown in FIGS. 2 and FIG. 4, the power supply control circuit 110 includes a first power supply control circuit 110a and a second power supply control circuit 110b, and the battery module 200 includes a first battery module 200a and a second battery module 200b.

It should be understood that although FIG. 4 illustrates a situation where the power supply control circuit 110 is disposed in the electric equipment 100, in an example of the present disclosure, the power supply control circuit 110 may also be at least partially disposed in the battery module 200, or the power supply control circuit 110 is independent of the battery module 200 and the electric equipment 100. The power supply control circuit 110 may be only disposed inside the electric equipment 100, may be only disposed inside the battery module 200, and may also be disposed independently of the electric equipment 100 and the battery module 200. In an example, the power supply control circuit 110 and the battery module 200 may be simultaneously disposed inside the electric equipment 100.

Further, in some implementations, the fast turn-on circuit 112 may include: a first switch transistor, a first resistor, and a second resistor, wherein the first switch transistor is connected between a control terminal of the switch circuit and a grounding terminal, the first resistor is connected between a first port of the main control module and a control terminal of the first switch transistor, and the second resistor is connected between a control terminal and a first terminal of the first switch transistor. The first port of the main control module is configured to output the fast start signal. As an example, referring to FIG. 4, in the first power supply control circuit 110a, the first switch transistor is a MOS transistor Q5, the first resistor is a resistor R9, and the second resistor is a resistor R11. In the second power supply control circuit 110b, the first switch transistor is a MOS transistor Q6, the first resistor is a resistor R10, and the second resistor is a resistor R12. The grounding terminal is marked as GND.

Further, in some implementations, the power supply detection circuit 113 may include: a second switch transistor, a third resistor, and a fourth resistor. The second switch transistor is connected between the control terminal of the switch circuit and the grounding terminal, the third resistor is connected between the auxiliary power supply control terminal of the battery module and a control terminal of the second switch transistor, and the fourth resistor is connected between the control terminal and a first terminal of the second switch transistor. The auxiliary power supply control terminal is configured to output the auxiliary power supply control signal. As an example, referring to FIG. 4, in the first power supply control circuit 110a, the second switch transistor is a MOS transistor Q3, the third resistor is a resistor R5, and the fourth resistor is a resistor R7. In the second power supply control circuit 110b, the second switch transistor is a MOS transistor Q4, the third resistor is a resistor R6, and the fourth resistor is a resistor R8.

Further, in some implementations, the power consumption control circuit 114 may include: a third switch transistor, a fifth resistor, and a sixth resistor. The third switch transistor is connected between the control terminal of the second switch transistor and the grounding terminal, the fifth resistor is connected between a second port of the main control module and a control terminal of the third switch transistor, and the sixth resistor is connected between the control terminal and a first terminal of the third switch transistor. The second port is configured to output the anti-power consumption signal. As an example, referring to FIG. 1, in the first power supply control circuit 110a, the third switch transistor is a MOS transistor Q7, the fifth resistor is a resistor R13, and the sixth resistor is a resistor R15. In the second power supply control circuit 110b, the third switch transistor is a MOS transistor Q8, the fifth resistor is a resistor R14, and the sixth resistor is a resistor R16.

Further, in some implementations, the switch circuit 111 includes: a fourth switch transistor, a seventh resistor, and an eighth resistor, wherein the fourth switch transistor is connected between the auxiliary power supply terminal of the battery module and the main control module, one end of the seventh resistor is connected to a control terminal of the fourth switch transistor, the other end of the seventh resistor receives the first switch control signal and the second switch control signal, and the eighth resistor is connected between the control terminal and a first terminal of the fourth switch transistor. As an example, referring to FIG. 4, in the first power supply control circuit 110a, the fourth switch transistor is a MOS transistor Q1, the seventh resistor is a resistor R3, and the eighth resistor is a resistor R1. In the second power supply control circuit 110b, the fourth switch transistor is a MOS transistor Q2, the seventh resistor is a resistor R4, and the eighth resistor is a resistor R2.

In some examples, the power supply control circuit 110 further includes an in-position detection circuit 115 connected to the main control module 120, and configured to generate a first signal when the battery module 200 is detected to be in position, and generate a second signal when the battery module 200 is detected to be removed. As an example, referring to FIG. 1, in the first power supply control circuit 110a, the in-position detection circuit 115 includes a resistor R17. In the second power supply control circuit 110b, the in-position detection circuit 115 includes a resistor R18.

In some examples, the main control module 120 is configured to: when the battery module 200 in a power supply state is detected to be removed, output the fast start signal to the fast turn-on circuit 112 corresponding to a first target battery module, such that the fast turn-on circuit 112 turns on the corresponding switch circuit 111, and notify the first target battery module to start to supply power to the load circuit 130.

In some examples, the main control module 120 is configured to, in response to a battery switching request, notify the battery module 200 in the power supply state to stop supplying power to the load circuit 130, and output the fast start signal to the fast turn-on circuit 112 corresponding to a second target battery module, such that the fast turn-on circuit 112 turns on the corresponding switch circuit 111, and notifies the second target battery module to start to supply power to the load circuit 130.

In some implementations, the main control module 120 is further configured to, in response to the battery switching request, output the anti-power consumption signal to the power consumption control circuit 114 corresponding to the battery module in the power supply state, such that the corresponding switch circuit 111 is disconnected by the corresponding power supply detection circuit 113.

In some implementations, the main control module 120 is further configured to, in response to the battery switching request, notify the battery module in the power supply state to output the auxiliary power supply control signal, such that the corresponding switch circuit 111 is disconnected by the corresponding power supply detection circuit 113.

In some examples, the main control module 120 is further configured to: when there are battery modules in position and none of the battery modules supplies power to the load circuit 130, determine a third target battery module according to a preset logic, and notify the third target battery module to start to supply power to the load circuit 130.

In some examples, the electric equipment 100 further includes a voltage conversion circuit 140 connected between the switch circuit 111 of each of the power supply control circuits 110 and the main control module 120, and configured to convert a voltage of the auxiliary power supply terminal of the battery module 200 into a working voltage of the main control module. In an example, the voltage conversion circuit 140 is further connected to the load power supply terminal of each of the battery modules 200, and is configured to convert a voltage of the load power supply terminal of the battery module 200 into the working voltage of the main control module 120.

In some examples, the electric equipment further includes: a unidirectional turn-on unit connected between each of the switch circuits and the voltage conversion circuit, and connected between each of the auxiliary power supply terminals and the voltage conversion circuit 140. As an example, referring to FIG. 4, the unidirectional turn-on unit includes a diode D1, a diode D2, and a diode D3.

In some examples, the control unit 210 is further configured to, when a disconnection notification of the main control module is received through the communication terminal, output the auxiliary power supply control signal indicating to disconnect the switch circuit to the power supply detection circuit through the auxiliary power supply control terminal.

In some implementations, referring to FIG. 4, before the first battery module 200a is inserted into the electric equipment, positive and negative poles of the battery are in a disconnected state, and after the first battery module 200a is inserted into the electric equipment, a pin 5 identifies that the first battery module 200a is inserted into a battery compartment of the electric equipment, a pin 4 outputs outward, the port 2 outputs a high level signal, voltage division is performed on the high level signal of the port 2 via R5 and R7, a voltage thereof is higher than a turn-on voltage of an N-channel MOS transistor Q3, the MOS transistor Q3 is turned on, then the resistor R3 is lowered, voltage division between the resistor R1 and the resistor R3 satisfies turning on of a P-channel MOS transistor Q1, the MOS transistor Q1 is turned on, a voltage of the port 4 is output via Q1 and the diode D1, and provided to the voltage conversion circuit of the electric equipment, and the voltage conversion circuit converts to obtain a working voltage VCC of the MCU. The working voltage supplies power to the MCU, satisfying turning on of the equipment.

When the second battery module 200b is inserted, a working order is the same as that of the first battery module 200a. At this time, the ports 4 of the two packs both supply power to the MCU. The MCU may select the battery module that supplies power in priority according to a logic set in advance, and respectively inform the two battery modules through the port 6 and the port 7 to continue to operate or be directly closed. Assuming that the first battery module 200a is selected to be turned on, the port 1/8 of the first battery module 200a is turned on, and the first battery module 200a supplies power to the load circuit of the electric equipment. The corresponding second battery module 200b may not supply power, and the MCU notifies the second battery module 200b to close the high level output of the port 2 or lower the high level signal through the anti-power consumption control signal, to disconnect the MOS transistor Q4 and the MOS transistor Q2. In this way, although the output of the port 4 of the second battery module 200b still exists, the path is disconnected, ensuring that no electricity is output from the port 4 and flows to the electric equipment to supply power to the MCU.

In some implementations, referring to FIG. 4, if the battery pack needs to be switched during a working process, the first battery module 200a may be notified through the ports 6 and 7 to close the output of the port 1/8, and simultaneously the MOS transistor Q6 and the MOS transistor Q2 are turned on through the fast start signal, the port 4 of the second battery module 200b performs output, subsequently the second battery module 200b is notified through the ports 6 and 7 to open the output of the port 1/8, and finally the MOS transistor Q7 is turned on through the anti-power consumption control signal, thereby disconnecting the MOS transistor Q3 and the MOS transistor Q1 and preventing power consumption from the port 4 of the first battery module 200a.

In some implementations, referring to FIG. 4, assuming that the first battery module 200a is discharging, when the first battery module 200a is pulled out, the connection between a resistor R21 and the resistor R17 is disconnected, voltage division of the resistor R17 and the resistor R21 changes, triggering an interrupt inside the MCU. At this time, since partial electric quantity still exists in a capacitor of an input terminal of the MCU, the power supply of the MCU is still sufficient to maintain operation, the MCU responds quickly, and controls the MOS transistor Q6 to be turned on through the fast start signal, thereby turning on the MOS transistor Q2, and an output signal of the port 4 of the second battery module 200b is provided to the voltage conversion circuit through the MOS transistor Q2 and the diode D3, ensuring that the MCU is not powered off.

The present disclosure provides a power supply control method for the above power supply control system, comprising:

Step 1, detecting an in-position situation of a battery module. The in-position situation includes whether main and sub battery modules are in position (e.g., present) and whether a charge level of the battery module is sufficient; and

Step 2, determining whether to switch the battery module for power supply according to a detection result of step 1. This step may include when the main battery module and the sub battery module are both in position and have sufficient charge levels, the main control module selects the main battery module to supply power according to a preset logic, and closes power supply of the sub battery module, without switching the power supply. When the main battery module and the sub battery module are both in position, the charge level of the main battery module is insufficient, and the charge level of the sub battery module is sufficient, the main control module can close the power supply of the main battery module, and switch to the power supply of the sub battery module. When the main battery module instantaneously switches from an in-position state to a non-in-position state, the main control module can switch to the power supply of the sub battery module. The battery module power supply includes load power supply and auxiliary power supply.

Step 3, selecting a switching manner of the battery module for power supply according to a determination result of step 2. For example, when the main battery module is in position, the main control module simultaneously outputs a communication signal and a fast start signal, the main control module sends the communication signal to the main battery module to close the load power supply, sends the fast start signal to the power supply control circuit corresponding to the sub battery module to start the auxiliary power supply, subsequently sends the communication signal to the sub battery module to start the load power supply, and sends an anti-power consumption signal to the power supply control circuit corresponding to the main battery module to close the auxiliary power supply. When the main battery module is not in position, the main control module sends the fast start signal to the power supply control circuit corresponding to the sub battery module to start the auxiliary power supply, and subsequently sends the communication signal to the power supply control circuit corresponding to the sub battery module to start the load power supply.

In some examples, when the main battery module and the sub battery module are both in position, the main battery module and the sub battery module both output a first signal and an auxiliary power supply control signal, and the main control module selects the main battery module for power supply according to the received first signal, the received auxiliary power supply control signal, and the preset logic.

A manner of turning off the power supply of the sub battery module may include that: the main control module sends the communication signal to the sub battery module, the sub battery module turns off the load power supply according to the communication signal, and the main control module sends the anti-power consumption signal to a sub power supply control circuit, to turn off the auxiliary power supply of the sub battery module; and a priority of the anti-power consumption signal is higher than a priority of the auxiliary power supply control signal.

In some examples, detection of the charge level of the battery module in position includes detecting whether a working voltage output by the battery module is smaller than a threshold voltage. If a working voltage output by the battery module is smaller than a threshold voltage, the detection result is that the charge level of the battery module is insufficient. The threshold voltage may be a power supply voltage ensuring normal operation of a load circuit.

The above are only preferred examples of the present disclosure and are not intended to limit the present disclosure. Although the present disclosure has been described in terms of preferred examples, they are not intended to limit the present disclosure, and any person skilled in the art can make some alternations or modifications into equivalent examples with the technical contents disclosed above, without departing from the scope of the technical solutions of the present disclosure. Any amendments, equivalent substitutions and modifications to the above examples made within the spirit of the present disclosure shall fall into the scope of the technical solutions of the present disclosure.

What is claimed is:

1. A power supply control circuit, comprising:
a switch circuit connected between an auxiliary power supply terminal of a battery module and a main control module;
a fast turn-on circuit connected to a control terminal of the switch circuit, wherein the fast turn-on circuit is configured to generate a first switch control signal based on a fast start signal received from the main control module;
a power supply detection circuit connected to the control terminal of the switch circuit, wherein the power supply detection circuit is configured to generate a second switch control signal based on an auxiliary power supply control signal received from the battery module, and wherein the switch circuit is turned on based on an indication from at least one of the first switch control signal or the second switch control signal; and
a power consumption control circuit connected to the power supply detection circuit, wherein the power consumption control circuit is configured to enable the power supply detection circuit based on an anti-power consumption signal received from the main control module.

2. The power supply control circuit of claim 1, wherein the fast turn-on circuit comprises:
a first switch transistor;
a first resistor; and
a second resistor, wherein:
the first switch transistor is connected between the control terminal of the switch circuit and a grounding terminal,
the first resistor is connected between a first port of the main control module and a control terminal of the first switch transistor,
the second resistor is connected between a control terminal of the first switch transistor and a first terminal of the first switch transistor, and
the first port of the main control module is configured to output the fast start signal.

3. The power supply control circuit of claim 1, wherein the power supply detection circuit comprises:
a second switch transistor;
a third resistor; and
a fourth resistor, wherein:
the second switch transistor is connected between the control terminal of the switch circuit and a grounding terminal,
the third resistor is connected between the auxiliary power supply terminal of the battery module and a control terminal of the second switch transistor,
the fourth resistor is connected between the control terminal of the second switch transistor and a first terminal of the second switch transistor, and
the auxiliary power supply terminal is configured to output the auxiliary power supply control signal.

4. The power supply control circuit of claim 3, wherein the power consumption control circuit comprises:
a third switch transistor,
a fifth resistor, and
a sixth resistor, wherein:
the third switch transistor is connected between the control terminal of the second switch transistor and the grounding terminal,
the fifth resistor is connected between a second port of the main control module and a control terminal of the third switch transistor,
the sixth resistor is connected between the control terminal of the third switch transistor and a first terminal of the third switch transistor, and
the second port is configured to output the anti-power consumption signal.

5. The power supply control circuit of claim 1, wherein the switch circuit comprises:
a fourth switch transistor,
a seventh resistor, and
an eighth resistor, wherein:
the fourth switch transistor is connected between the auxiliary power supply terminal of the battery module and the main control module,
a first end of the seventh resistor is connected to a control terminal of the fourth switch transistor,
a second end of the seventh resistor is configured to receive the first switch control signal and the second switch control signal, and
the eighth resistor is connected between the control terminal of the fourth switch transistor and a first terminal of the fourth switch transistor.

6. The power supply control circuit of claim 1, further comprising: an in-position detection circuit connected to the main control module, wherein the in-position detection circuit is configured to generate a first signal when the battery module is detected to be connected and generate a second signal when the battery module is detected to be removed.

7. A power supply control system, comprising:
a main control module;
a first power supply control circuit coupled to the main control module;
a second power supply control circuit coupled to the main control module;
a first battery module coupled to the first power supply control circuit; and
a second battery module coupled to the second power supply control circuit,
wherein the first power supply control circuit comprises:
a switch circuit connected between an auxiliary power supply terminal of the first battery module and the main control module;
a fast turn-on circuit connected to a control terminal of the switch circuit, wherein the fast turn-on circuit is configured to generate a first switch control signal based on a fast start signal received from the main control module;
a power supply detection circuit connected to the control terminal of the switch circuit, wherein the power supply detection circuit is configured to generate a second switch control signal based on an auxiliary power supply control signal received from the first battery module, and wherein the switch circuit is turned on based on an indication from at least one of the first switch control signal or the second switch control signal; and
a power consumption control circuit connected to the power supply detection circuit, wherein the power consumption control circuit is configured to enable the power supply detection circuit based on an anti-power consumption signal received from the main control module.

8. The power supply control system of claim 7, wherein the main control module is configured to: based on detecting removal of the first battery module, send the fast start signal, and control the second battery module to start to supply power.

9. The power supply control system of claim 7, wherein the main control module is configured to:
in response to a battery switching request, notify the first battery module to stop supplying power, send the fast start signal, and control the second battery module to start to supply power.

10. The power supply control system of claim 9, wherein the main control module is further configured to, in response to the battery switching request, send the anti-power consumption signal to the power consumption control circuit.

11. The power supply control system of claim 9, wherein the main control module is further configured to, in response to the battery switching request, control the first battery module to send the auxiliary power supply control signal.

12. The power supply control system of claim 7, wherein the main control module is further configured to: based on a determination that no connected battery module is supplying power, control one of the first battery module or the second battery module to start to supply power.

13. The power supply control system of claim 7, further comprising: a voltage conversion circuit connected between the switch circuit and the main control module, wherein the voltage conversion circuit is configured to convert a voltage of the auxiliary power supply terminal of the first battery module into a working voltage of the main control module.

14. The power supply control system of claim 13, wherein the voltage conversion circuit is further connected to a load power supply terminal of the first battery module, and is configured to convert a voltage of the load power supply terminal of the first battery module into the working voltage of the main control module.

15. The power supply control system of claim 14, further comprising: a unidirectional turn-on unit connected between the switch circuit and the voltage conversion circuit, and between the load power supply terminal and the voltage conversion circuit.

16. The power supply control system of claim 7, wherein the first battery module comprises:
an auxiliary power supply terminal configured to supply power to the main control module;
a load power supply terminal configured to supply power to a load circuit;
a communication terminal in communication connection with the main control module;
an auxiliary power supply control terminal configured to generate the auxiliary power supply control signal;
an equipment detection circuit configured to generate a first signal based on a determination that the first battery module is detected to be coupled to the first power supply control circuit, and generate a second signal based on a determination that the first battery module is detected to be removed; and
a control unit configured to:
based on a determination that the first battery module is detected to be coupled to the first power supply control circuit, send the auxiliary power supply control signal indicating turning on the switch circuit to the power supply detection circuit through the auxiliary power supply control terminal, and
based on a determination that a power supply notification of the main control module is received through the communication terminal, start to supply power from the load power supply terminal to the load circuit.

17. The power supply control system of claim 16, wherein the control unit is further configured to, based on a determination that a disconnection notification of the main control module is received through the communication terminal, send the auxiliary power supply control signal indicating to disconnect the switch circuit to the power supply detection circuit through the auxiliary power supply control terminal.

18. A power supply control system comprising:
a main control module;
a first power supply control circuit coupled to the main control module;
a second power supply control circuit coupled to the main control module;
a first battery module coupled to the first power supply control circuit; and
a second battery module coupled to the second power supply control circuit, wherein the main control module is configured to:
determine that a charge level of the first battery module is insufficient, and
control, based on a determination the charge level of first battery module is insufficient or based on detecting that the first battery module is to be removed, the first battery module to stop supplying power, and the second battery module to start to supply power.

19. The power supply control system of claim 18, wherein the first power supply control circuit comprises:
a switch circuit connected between an auxiliary power supply terminal of the first battery module and the main control module;
a fast turn-on circuit connected to a control terminal of the switch circuit, wherein the fast turn-on circuit is configured to generate a first switch control signal based on a fast start signal received from the main control module;
a power supply detection circuit connected to the control terminal of the switch circuit, wherein the power supply detection circuit is configured to generate a second switch control signal based on an auxiliary power supply control signal received from the first battery module, and wherein the switch circuit is turned on based on receiving at least one of the first switch control signal or the second switch control signal; and
a power consumption control circuit connected to the power supply detection circuit, wherein the power consumption control circuit is configured to enable the power supply detection circuit based on an anti-power consumption signal received from the main control module.

20. The power supply control system of claim 19, wherein the main control module is further configured to, in response to a battery switching request, send an anti-power consumption signal to the power consumption control circuit.
